(19) United States
(12) Patent Application Publication
(10) Pub. No.: US 2016/0330164 A1
(43) Pub. Date: Nov. 10, 2016

(54) System and Method of Federating a Cloud-Based Communications Service with a Unified Communications System

(71) Applicant: NextPlane, Inc., Sunnyvale, CA (US)

(72) Inventors: Saravanan Bellan, San Jose, CA (US); Sanjay M. Pujare, San Jose, CA (US); Yogesh Raina, Cupertino, CA (US); Farzin Khatib Shahidi, Los Altos Hills, CA (US); Silvia Restelli, San Jose, CA (US)

(73) Assignee: NEXTPLANE, INC., Sunnyvale, CA (US)

(21) Appl. No.: 14/705,929

(22) Filed: May 6, 2015

(51) Int. Cl. H04L 12/58; H04L 29/08

(52) U.S. Cl. CPC H04L 51/36; H04L 67/10

(57) ABSTRACT

A system and method of federating a cloud-based communications service with a unified communications system is disclosed. According to one embodiment, a system includes a federation system that is connected to a first domain of a unified communications system and a second domain of a cloud-based communications service. The federation system assigns the second domain to a first network region via a first network card, provides a first request to a certification authority to issue a first digital certificate, where the first request includes an attribute of the first domain. The federation system further receives the first digital certificate from the certification authority, presents the first digital certificate to the first network region, and federates the first domain and the second domain based on the first digital certificate.

### FIELD

The present disclosure relates in general to unified communications (UC) systems. In particular, the present disclosure relates to a system and method of federating a cloud-based communications service with a unified communications system.

### BACKGROUND

A unified communications (UC) system generally refers to a system that provides users with an integration of communications services. A user typically connects to the UC system through a single client to access the integrated communications services. The integrated communications services may include real-time services, such as instant messaging (IM), presence notifications, telephony, and video conferencing, as well as non-real-time services, such as email, SMS, fax, and voicemail.

Organizations, such as corporations, businesses, educational institutions, and government entities, often employ UC systems to enable internal communication among its members in a uniform and generally cost-efficient manner. In addition, organizations may employ UC systems for communicating with trusted external entities. Currently, a number of third-party developers offer various UC applications for implementing UC systems. The various applications include Microsoft Office Communications Server (OCS), IBM Sametime (ST), Google Apps, and Cisco Jabber.

A user may also connect to a cloud-based communications service that provides a cloud-based subscription service for document processing applications. For example, Office365 is Microsoft's hosted or cloud-based subscription service for Microsoft's Office software suite. The cloud-based communications service further allows a user of an organization to access collaboration capabilities on the cloud, including presence, IM, audio/video calls, rich online meetings, and web conferencing capabilities without the need for an on-premise unified communications system.

Although a cloud-based communications service is based on and similar to an on-premise unified communications system, there is still difficulty in supporting federation between a cloud-based communications service and an on-premise unified communications system.

### SUMMARY

A system and method of federating a cloud-based communications service with a unified communications system is disclosed. According to one embodiment, a system includes a federation system that is connected to a first domain of a unified communications system and a second domain of a cloud-based communications service. The federation system assigns the second domain to a first network region via a first network card, provides a first request to a certification authority to issue a first digital certificate, where the first request includes an attribute of the first domain. The federation system further receives the first digital certificate from the certification authority, presents the first digital certificate to the first network region, and federates the first domain and the second domain based on the first digital certificate.

The above and other preferred features, including various novel details of implementation and combination of elements, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments.

### BRIEF DESCRIPTION OF THE FIGURES

The accompanying figures, which are included as part of the present specification, illustrate the various embodiments of the present disclosed system and method and together with the general description given above and the detailed description of the preferred embodiments given below serve to explain and the teach the principles of the present disclosure.

FIG. 1 illustrates a block diagram of a prior art system for interconnecting three UC systems using custom and federation links;

FIG. 2 illustrates a block diagram of a prior art system for interconnecting four UC systems using custom and federation links;

FIG. 3 illustrates a block diagram of an exemplary highly scalable system for interconnecting UC systems, according to one embodiment;

FIG. 4 illustrates a block diagram of an exemplary hub that is implemented as cloud services, according to one embodiment;

FIG. 5 illustrates a block diagram of an exemplary hub that is connected to each of three realms, according to one embodiment;

FIG. 6 illustrates a flow chart of an exemplary process for processing messages received from a UC system, according to one embodiment;

FIG. 7 illustrates a block diagram that traces an exemplary transmission of a message through a hub and domain gateways, according to one embodiment;

FIG. 8 illustrates a block diagram that traces an exemplary transmission of a message through a hub using Service (SRV) record publication, according to one embodiment;

FIG. 9 illustrates a block diagram of an exemplary system for federating a cloud-based communications service with a unified communications system, according to one embodiment;

FIG. 10 illustrates a block diagram of an exemplary system for federating a cloud-based communications service with one or more unified communications systems, according to one embodiment;

FIG. 11 illustrates another block diagram of an exemplary system for federating a cloud-based communications service with one or more unified communications systems, according to one embodiment;

FIG. 12 illustrates a flow chart of an exemplary process for providing a digital certificate to establish a federation between two or more domains, according to one embodiment;

FIG. 13 illustrates a flow chart of an exemplary process for realm routing, according to one embodiment; and

FIG. 14 illustrates an exemplary computer architecture that may be used for the present system, according to one embodiment.

It should be noted that the figures are not necessarily drawn to scale and elements of similar structures or functions are generally represented by like reference numerals for illustrative purposes throughout the figures. It also should be noted that the figures are only intended to facilitate the description of the various embodiments described herein. The figures do not describe every aspect of the teachings disclosed herein and do not limit the scope of the claims.

### DETAILED DESCRIPTION

A system and method of federating a cloud-based communications service with a unified communications system is disclosed. According to one embodiment, a system includes a federation system that is connected to a first domain of a unified communications system and a second domain of a cloud-based communications service. The federation system assigns the second domain to a first network region via a first network card, provides a first request to a certification authority to issue a first digital certificate, where the first request includes an attribute of the first domain. The federation system further receives the first digital certificate from the certification authority, presents the first digital certificate to the first network region, and federates the first domain and the second domain based on the first digital certificate

Each of the features and teachings disclosed herein can be utilized separately or in conjunction with other features and teachings to provide a system and method of federating a cloud-based communications service with a unified communications system. Representative examples utilizing many of these additional features and teachings, both separately and in combination, are described in further detail with reference to the attached figures. This detailed description is merely intended to teach a person of skill in the art further details for practicing preferred aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The methods or algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

According to one embodiment, the present system provides a hub that provisions a domain of a cloud-based communications service. The present system further provides a hub that establishes a federation between a domain of a UC system and a domain of a cloud-based communications service. The present disclosure is related to co-pending U.S. patent application Ser. No. 13/077,710 entitled “Hub Based Clearing House for Interoperability of Distinct Unified Communications Systems” filed on Mar. 31, 2011, which is fully incorporated herein by reference.

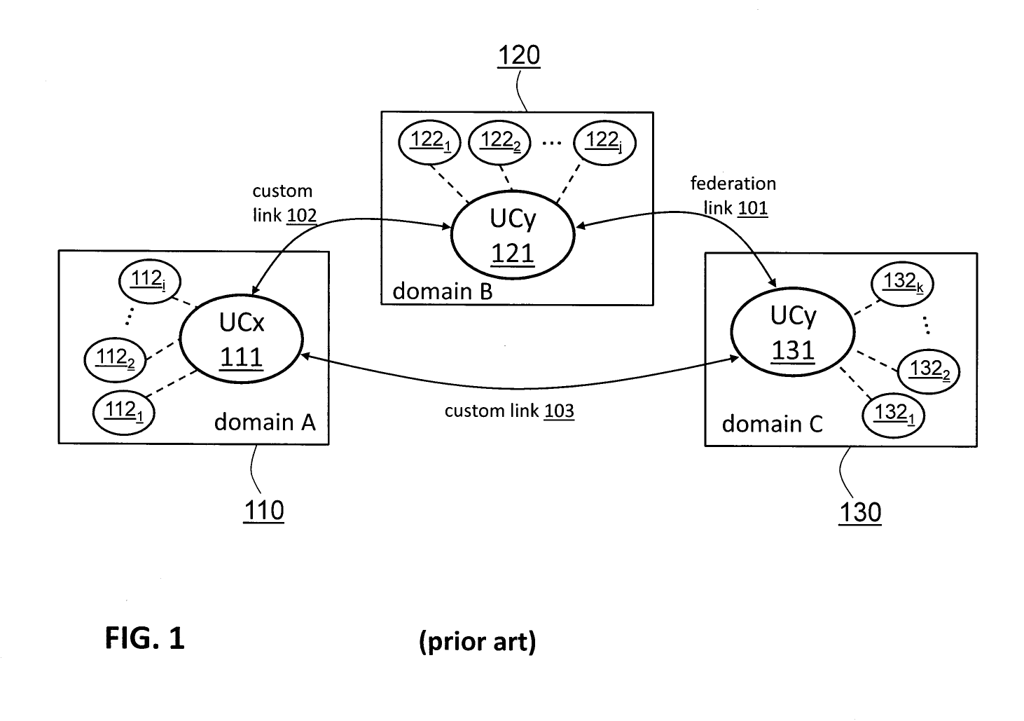

FIG. 1 illustrates a block diagram of a prior art system for interconnecting three UC systems using custom and federation links. UC system 111 is running the UC application denoted as “UCx” and UC systems 121 and 131 are running a different UC application denoted as “UCy”. Each UC system supports a different domain and is accessible (e.g., instant messaging, emailing, videoconferencing, etc.) by its respective set of users in the domain. As such, users 112₁-112ᵢ in domain A 110 can communicate with one another through UC system 111. Similarly, users 122₁-122ⱼ in domain B 120 and users 132₁-132ₖ in domain C 130 can access UC systems 121 and 131, respectively, to communicate with other users in the same domain. Because a user generally interacts with a UC system through a user client device (“client”), the terms “user” and “client” are used interchangeably in this disclosure.

Issues arise, for instance, when users in domain B 120 need to communicate with users in domain A 110 or users in domain C 130. Without a communications link between users in two different domains, the users in a domain can only communicate (through its UC system) with users in the same domain. Here, as FIG. 1 illustrates, federation link 101 provides a communications link between UC system 120 and 130. A federation link allows users in different domains to communicate with each other so long as the associated UC systems are running the same UC application. In this case, because UC systems 121 and 131 both run UC application “UCy”, federation link 101 allows users 122₁-122ⱼ to communicate with users 132₁-132ₖ. Whether a federation link is available depends on the particular UC system.

However, where the UC systems are not running the same UC application, as between UC system 111 and UC system 121, there is typically no federation link available because a third-party developer would only provide support for its own product. Historically, one way to provide a communications link between UC systems 111 and 121 is to build a custom link 102, as FIG. 1 illustrates. Custom link 102 includes a translator that translates messages from UC system type “UCx” to UC system type “UCy” and specifically between domains 110 and 120. Because building a custom link is generally expensive in both time and resources, it is not an optimal solution.

Furthermore, custom links are not scalable. As FIG. 1 illustrates, even after a custom link 102 is implemented between domain A 110 and domain B 120, a second custom link 103 would need to be implemented in order for users in domain A 110 to communicate with users in domain C 130. Thus, implementing the infrastructure of FIG. 1 requires three unique communications links.

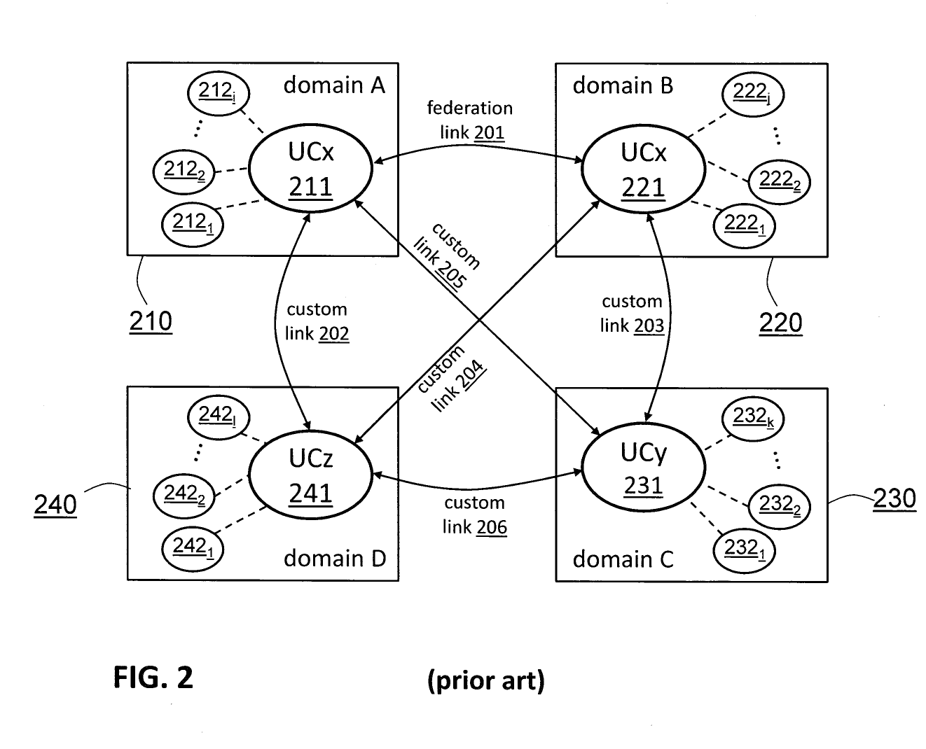

FIG. 2 illustrates a block diagram of a prior art system for interconnecting four UC systems using custom and federation links. As FIG. 2 illustrates, the scaling problem escalates when four UC systems in four different domains are interconnected using custom and federation links. Federation link 201 between UC systems 211 and 221 provides a communications support between users in domain A 210 and users in domain B 220. Federation link 201 is available as both associated UC systems 211 and 221 run the same UC application denoted by “UCx”. Because UC systems 231 and 241 each run different UC applications (denoted by “UCy” and “UCz” respectively), the infrastructure of FIG. 2 requires implementing six unique communications links (five custom links 202-206 and one federation link 201) in order for users in any of the four domains to communicate with one another. Thus, the complexity of implementing custom links essentially doubled (from the implementation of FIG. 1 to FIG. 2) by adding just one UC system running a different UC application. As such, infrastructures that employ custom links are not scalable. There exists a need for a highly scalable system for interconnecting distinct and independent UC systems in a federated manner to provide communications support among users of the UC systems.

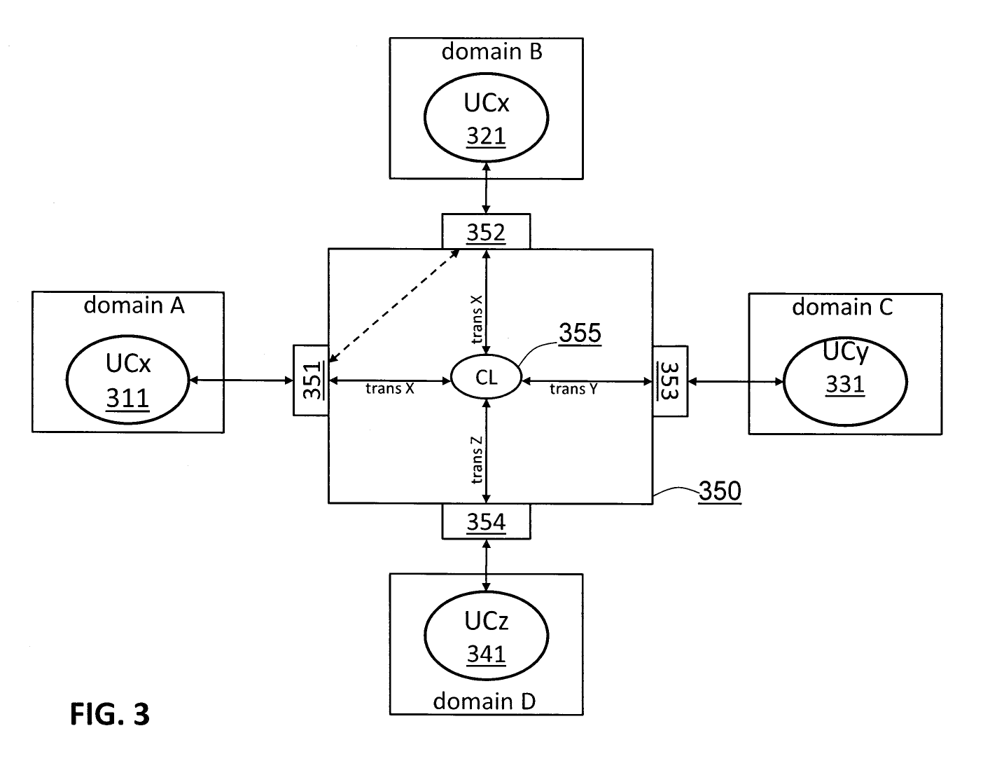

FIG. 3 illustrates a block diagram of an exemplary highly scalable system for interconnecting UC systems, according to one embodiment. While FIG. 3 only illustrates interconnecting four UC systems 311,321,331, and 341, the present system can interconnect and support any number of UC systems. The exemplary system of FIG. 3 employs a hub 350 that includes four connectors 351-354. Although FIG. 3 illustrates that each connector communicates with one of the four UC systems 311, 321, 331, and 341, each connector can support any number of UC systems as long as the connector and the UC systems utilize or speak the same protocol (e.g., Session Initiation Protocol (SIP), Extensible Messaging and Presence Protocol (XMPP), or any other) and are within reach of one another in terms of network connectivity. Generally, one connector per UC protocol is needed per realm. A realm is the network region that is reachable from a network interface (to which the connector is bound).

The hub 350 acts as a central station for translating incoming data from any supported UC system into a common language (CL) 355. Depending on the UC application that is implemented on the receiving UC system, the CL 355 is then translated into the language that is supported by the receiving UC system. For instance, a message that is transmitted by UC system 331 and intended for UC system 341 is first transmitted to the hub 350 via connector 353. The message is then translated by hub 350 into a CL 355. Because the message is intended for UC system 341, the CL 355 is then translated into the language that is recognized by the UC application denoted by “UCz” and transmitted to UC system 341 via connector 354.

Similarly, a message that is transmitted by UC system 321 and intended for UC system 341 is first transmitted to the hub 350 via connector 352 and then translated into a CL 355. Again, the CL 355 is then translated into the language that is recognized by the UC application denoted by “UCz” and transmitted to UC system 341 via connector 354. In the case in which two UC systems are running the same UC application, the hub may route a message sent from one UC system to the other without performing translations. As FIG. 3 further illustrates, the hub 350 may, for instance, route a message sent by UC system 311 to UC system 321 without performing translations, as indicated by the perforated line.

The hub may also perform direct translation (e.g., from “UCy” type to “UCz” type) without first translating the message into a CL. Direct translation may be used to achieve higher efficiency and to maintain high fidelity communications.

Under the exemplary embodiment of FIG. 3, each UC system thinks that it is communicating with a UC system that is running the same UC application as itself. Rather than having to maintain separate federations among each particular domain, as illustrated in FIGS. 1 and 2, a network administrator can create a clearing house community that connects multiple domains through a single hub. One advantage of the exemplary system of FIG. 3 is its scalability. For instance, consider adding to the infrastructure of FIG. 3 an additional UC system that is implemented on a new UC application and is associated with a new domain. The addition may simply be implemented by adding the functionality (a one-time job) for translating between the language used by the new UC application and the common language. Depending on the network configurations, an allow list may also need to be updated (also a one-time job) to include any existing or added domain that does not publish an SRV record (discussed more later). Once added, the new UC system would be able to communicate with any of the UC systems already connected to the hub and vice versa.

In addition to solving the scalability issues described above, the hub or clearing house system illustrated in FIG. 3 also provides for the ability to implement additional features. For instance, the present hub may provide for preservation of high fidelity communication. This disclosure contemplates employing a common language (CL) format that provides for full translation from one UC language format to another without unnecessary or unavoidable loss of information. This may be accomplished by translating the UC formatted message into a CL formatted message such that no data is discarded until the CL formatted message is translated into the UC format that is recognized by the receiving UC system. Unlike using a lowest common denominator approach to defining the CL in which all communications are lowered to the UC language format with the least common functionality, employing a CL format that provides for full translation preserves high fidelity communication between UC systems.

Consistent with one embodiment, the CL is a superset language that supports features (e.g., fields) of all supported UC language formats. For instance, the CL may contain some or all the fields of a supported UC language format. Also, the CL may be an evolving language wherein new syntax (headers) can be added to accommodate any new features that become available in supported UC systems. The new syntax may then be used by all the translators to translate a CL formatted message into a message of respective UC format that supports these new features. In one embodiment, an appropriate CL format is generic SIP.

The hub system also allows administrators to set and enforce policies by virtue of it being a hub for all inter-domain communication. When a UC system in one domain communicates directly (without going through a hub) with a UC system in another domain, administrators of each domain can only control incoming and outgoing messages locally. However, if the UC systems communicate with each other through a hub, the hub allows administrators of each UC system to access the part of the hub that applies to them so that they can administer policies that are not possible to administer locally. For instance, an administrator may administer one or more policies through the hub to allow a user in one domain to make his status appear as available to only certain members of another domain. Such granular control in setting policies is generally not available to administrators of domains interconnected using just federation and custom links.

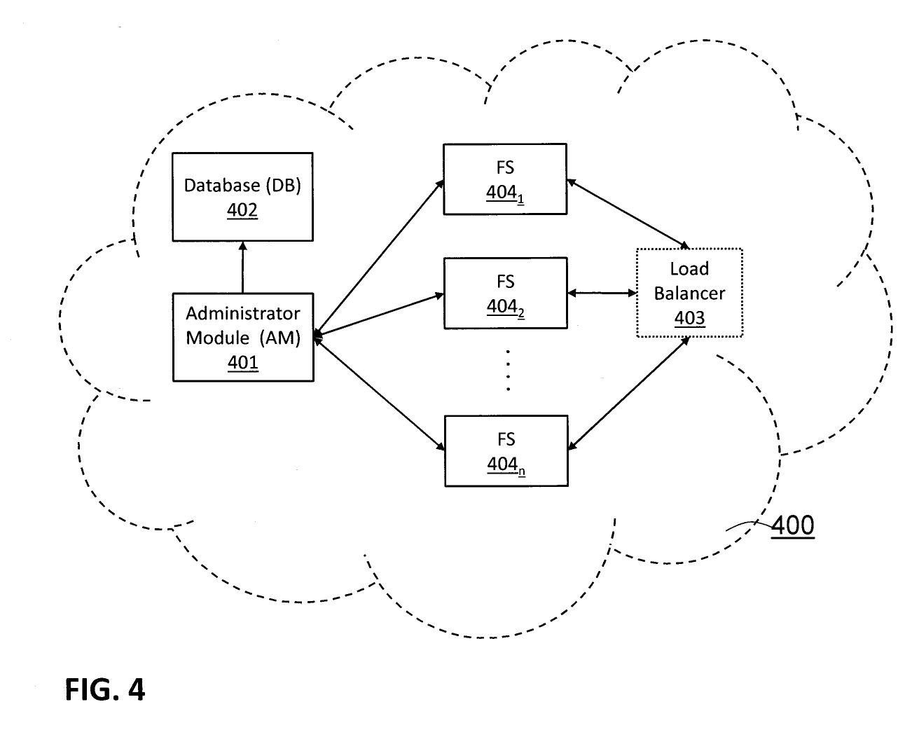

FIG. 4 illustrates a block diagram of an exemplary hub that is implemented as cloud services, according to one embodiment. That is, a hub does not necessarily run on a particular server installation or from any particular location. A hub may be broken into four main components: an administration module (AM), a database (DB), a federation server (FS), and a load balancer (LB). While a hub may be implemented using a single computer, FIG. 4 illustrates an exemplary embodiment in which the hub is implemented using several computers, each computer carrying out a specific function, and networked together to create a single installation.

Hub 400 includes an administration module implemented on computer 401. An administration module (AM) is a software program that allows hub system administrators to configure the hub to provide UC systems with access to the hub. There is typically one AM for each installation. The AM configures the hub by creating and updating a data store in a database (DB) implemented on computer 402. The data store contains the information that is used by the federation servers (FS's) to perform their functions. Each of the FS's may be implemented on separate computers 404₁₋ₙ. FIG. 4 further illustrates an optional load balancer 403 that manages and directs communications traffic from UC systems to the FS's to make efficient use of the available system resources.

Some of the configurable parameters and desired settings of the AM are as follows:

### 1. Administrator Settings

a. In the administration settings the hub administrator can configure the hub to allow for public federation (e.g., allowing the hub to connect to public instant messenger systems such as Google Chat, AIM, and Yahoo Messenger).
b. A default setting allows federation even if no policy applies to a message. This can be reversed by the administrator so that federation is allowed only if a policy applies to a message.

### 2. Realms

a. A physical network card in the FS machine may be configured to support one or more connectors, one connector per protocol. A connector is created by configuring a physical network card to use a supported protocol, such as SIP or XMPP or both, and is described in further detail below.

### 3. Private Keys and Certificates

a. Private and public keys may be configured within the hub so that the FS can communicate with UC systems securely. The AM allows private keys to be created for the hub by creating a self-signed key and then creating a certificate signing request which is sent to a certification authority (CA) such as Verisign or Entrust. The reply to the request is imported back into the hub, at which point, the hub can send its public certificate to all the connected UC systems.
b. The AM acquires public certificates for all domains it would communicate with. The AM fetches the certificate for a domain present in the data store provided the hub is able to communicate over transport layer security (TLS) with this domain.

### 4. Federation Servers

a. The AM allows administrators to create, edit, and delete servers after the server has been physically built with the proper hardware. The proper settings for creating a federation server depend on the number of network cards installed on the server. Each network card may be configured to use each type of connector that is used within the realm that it is associated or may serve as a spare or may be used for other communication purposes (e.g., to DB or to the AM). A connector typically supports a single UC protocol (e.g., SIP or XMPP). However, a connector may have multiple transports configured for its UC protocol (e.g., a SIP connector configured to support SIP over TLS and SIP over transmission control protocol (TCP) and an XMPP connector configured to support XMPP over TCP and XMPP over TLS).
b. The administrator must also configure private keys and corresponding public keys and certificates so the AM can communicate internally with each FS in the installation securely. The AM and each FS communicate over TLS which requires that the AM and each FS have a private key and that the corresponding certificates (public keys) are available to the other side. This enables the AM and each FS to communicate internally over TLS.

### 5. Domains

The following information for each domain that will be communicating through the hub are added to the database:
   i. Domain name (e.g., UC4.acme.com)
   ii. Whether the Domain is public or not
   iii. One of the following methods of acquiring the IP address is required:
      1. Use domain name system (DNS) SRV record to fetch the IP address
      2. Use the fully qualified domain name (FQDN) to fetch the IP address
      3. Input the IP Address directly

### 6. Policies

a. Each policy has a name and action flags (e.g., allow, deny). There may be six types of messages that flow thru the hub: buddy invite, presence, chat, audio call, video call, and file transfer. The criteria for the policy can be specified in a structured fashion using lists and attributes of addresses involved in the address.
   i. Policy actions
      1. Buddy list invites can be allowed or denied.
         (A buddy list invite (or SUBSCRIBE as it is called in SIP/XMPP) is sent from user A to user B via the hub when user A adds user B to his contact (buddy) list)
      2. Instant Messages can be allowed or denied
      3. Presence can be allowed or denied
      4. Audio calls
      5. Video calls
      6. File transfer
   ii. Policy lists: System administrators create lists in the database which can be referenced in the policy rules. Each list may be used by the policy rules described above. The following are the types of lists that can be created by the administrators:
      1. List of Addresses
      2. List of Domains
      3. List of Groups (e.g., Using Microsoft Active Directory)
   iii. Criteria: policy criteria are specified in each policy. These criteria determine when a policy is applied to a message (specifically the source and destination addresses) being processed. Up to five criteria can be specified and each criterion applies to source, destination, both or either address in the message. The operation specified on the address(es) may be one of: is-internal, is-external, is-public, is-present-in-list or the negation of one of them.

### 7. Directory (for Microsoft Active Directory Functionality)

a. Administrator can populate users and groups in the data store by having the hub connect to an active directory and download the users and groups, which eliminates duplication of data already present. Once these users and groups are downloaded, the administrator can reference them in the policies as described above.

Once the AM and the connected UC systems have been properly configured, individual users on a configured UC system can connect to other users on any other properly configured (remote or local) UC system.

As mentioned earlier, the AM configures the hub by creating and updating a data store in a database (DB) implemented on computer 402. In addition to storing configuration data received from the AM, the DB also stores data regarding local administrators (administrators of UC systems connected to the hub), local users (users in the domains of associated UC systems), and FS's. In general, because only the AM can directly manipulate data in the DB, local administrators who wish to update the DB data would have to log into the AM to do so. Local user information that may be stored in the DB include usage and audit logging information. The DB may be implemented as a relational data base.

FIG. 4 illustrates that each of the FS's may be implemented on separate computers 404₁₋ₙ. The computers 404₁₋ₙ, are substantially identical to one another regarding their physical hardware configurations. Each FS computer typically has three network cards installed. However, more than or less than three network cards per computer are also contemplated. Furthermore, the software applications installed on each of the computers 404₁₋ₙ, are configured in almost an identical fashion to one another except that each computer is given a unique identification value.

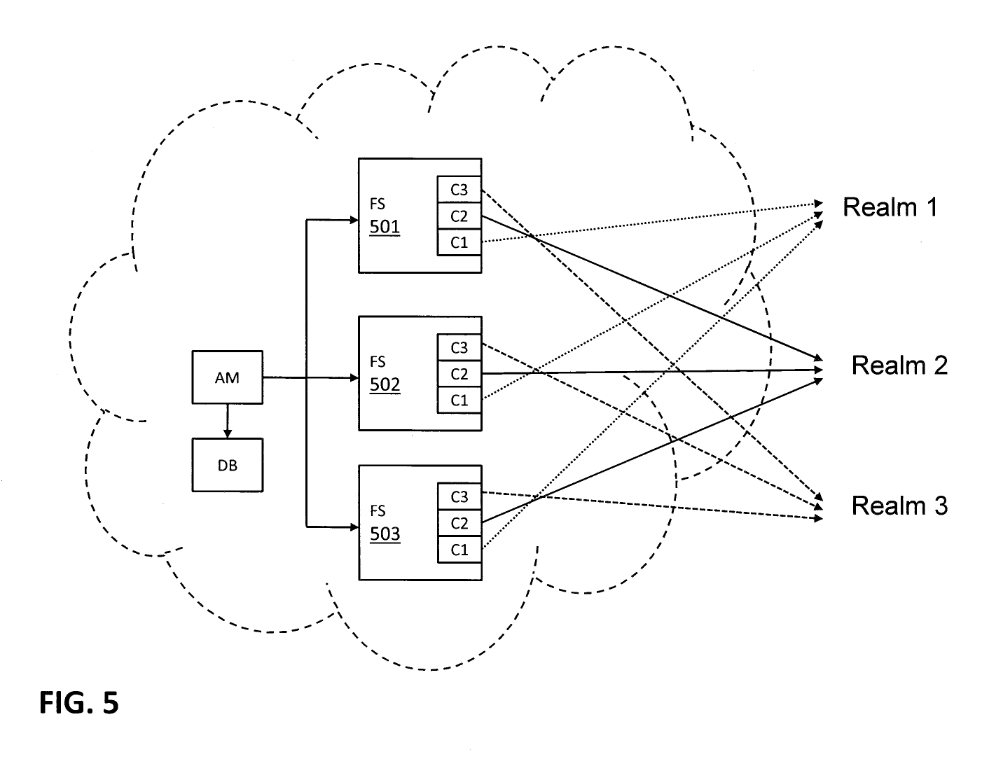

FIG. 5 illustrates a block diagram of an exemplary hub that is connected to each of three realms, according to one embodiment. Each of the computers 501-503 has three network cards (C1, C2, and C3) installed. In order for each FS to provide access to each of the three realms, each network card of a FS is connected to a different realm. A realm is a network region or network segment that is reachable through a particular network card. For instance, in an enterprise network there is often an internal network (e.g., intranet) and an external network (e.g., Internet). A computer sitting in the demilitarized zone (DMZ) of the enterprise may need a network card to access the intranet (e.g., realm 1) and another network card to access the Internet (e.g., realm 2). Any number of realms may exist. Another example of a realm is a private network that is accessible through a private link (e.g., remote branch office).

A FS has two main components: (1) instances of connectors, and (2) the DP Application Logic (herein “engine”). A connector is an object that includes both a hardware aspect and a software aspect. The hardware aspect includes a physical network card connection that provides a physical pathway for data to flow into and out of a FS machine. The software aspect of a connector, in its basic form, is comprised of (1) a listening loop that listens on the physical connection and waits for incoming data, and (2) a function that can be called by the FS when data is ready to be sent out from a network card of the FS.

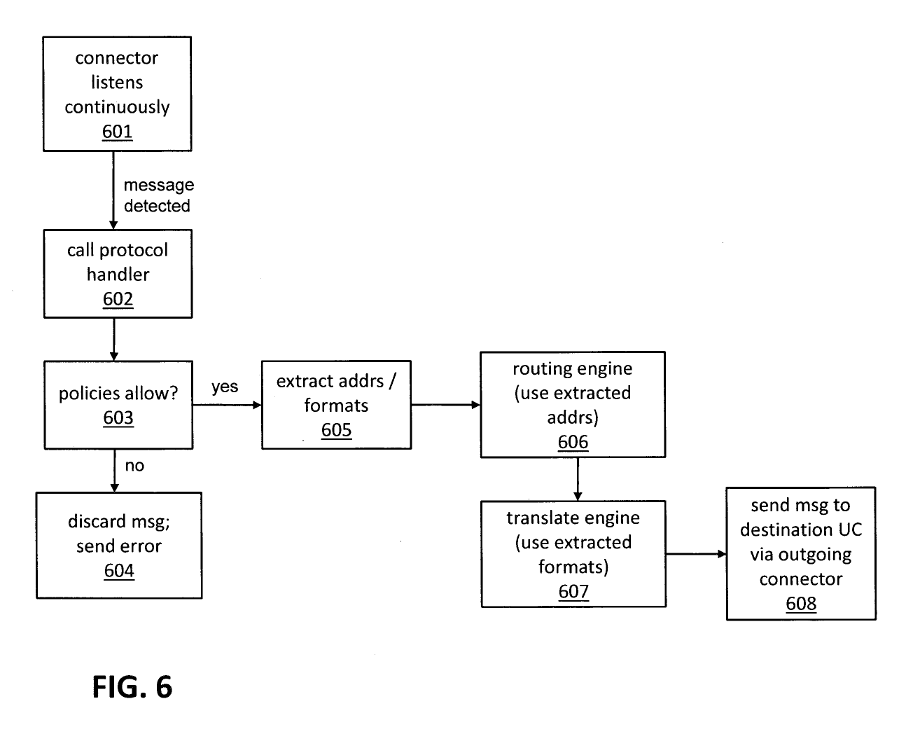

FIG. 6 illustrates a flow chart of an exemplary process for processing messages received from a UC system, according to one embodiment. The operations begin with the connectors of the FS continuously listening (at 601) for an on-the-wire message, such as a SIP or XMPP message. If a message is detected, a protocol handler is called (at 602) to translate the detected on-the-wire message into an internal memory representation of the message (IMRM). After translating into an IMRM, the hub message manager (HMM) uses a policy enforcement engine to check the IMRM against policies set up by the administrators (at 603) and decides whether the IMRM should be allowed. If the IMRM is found not to be allowed, an error message is sent back to the incoming connector which received the message and the IMRM is discarded (at 604). The error message, which may include information as to why the message was not allowed, is relayed back to the originating UC through the incoming connector. On the other hand, if the IMRM is found to be allowed, the HMM extracts the destination and source addresses as well as the destination and source UC formats from the IMRM (at 605). Using the extracted addresses, the HMM uses a routing engine to determine the destination route for the IMRM (at 606). The routing engine also adds necessary information to the IMRM to ensure the message is ready for the destination domain. For instance, the added information may include routing headers that allow SIP and XMPP outgoing connectors to route the message to the appropriate UC systems. Next, the HMM processes the IMRM using a translation engine (at 607). The translation engine first checks the data store to see if direct translation is available. If so, direct translation is used. If not, the translation engine translates the IMRM into the CL format and then translates the CL formatted message into the destination UC format. The translation engine uses the formats that were extracted at 605. After translation into the destination UC format, the message is translated into an on-the-wire format and then sent out to the destination UC system via an outgoing connector (at 608). The outgoing connector is determined by the routing engine at 606 and it uses the realm and the UC protocol of the destination UC system. Thus, a connector is used for both sending and receiving messages.

In order for UC systems to communicate with each other through a hub, the local domain administrators of the UC systems need to properly configure their systems so that communications traffic intended for a receiving UC system is directed to the hub. For instance, in a clearinghouse or hub implementation, a domain gateway is typically implemented. The domain gateway is a component that allows the UC system to communicate with the hub. In order for a UC system to communicate with the hub, both the domain gateway and the UC system need to be configured properly.

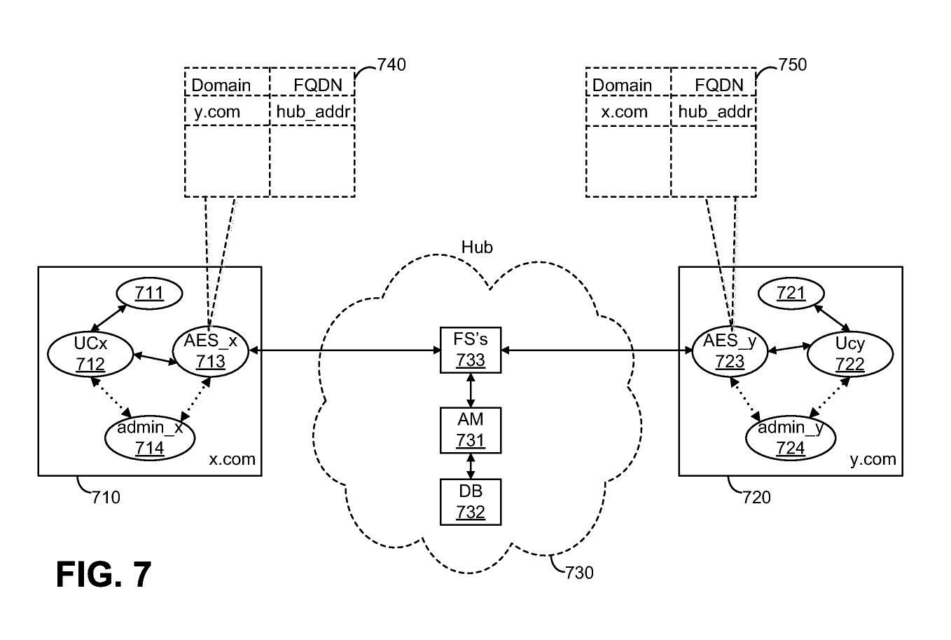

FIG. 7 illustrates a block diagram that traces an exemplary transmission of a message through a hub and domain gateways, according to one embodiment. Assume user 711 wants to send a message to user 721. User 711 first sends the message to the local UC system 712. The message is then forwarded to domain gateway 713 (e.g., Access Edge Server (AES), and Same Time Gateway) which maintains an allow list 740 of all the domains the local domain administrator 714 has allowed its users to have access to. This way, local domain administrators have control over which domains its users can communicate with. Additionally, the allow list can be used allow or disallow communication with federated domains. Another useful function of the allow list is to provide UC address information for federated domains.

In order to route communications traffic that is intended for domain “y.com” (720) to the hub 730, the allow list 740, specifically the FQDN field in the entry for domain “y.com” (720), needs to include the address of the hub 730 (“hub_addr”). Furthermore, the hub 730 must also be properly configured by the hub administrator, who must add both domains (“x.com” and “y.com”) to the hub 730 through the AM 731. Once the hub administrator has configured the AM 731 and the AM 731 has updated the data store in the DB 732, the hub 730 is ready for use and all traffic to and from “x.com” to “y.com” will flow through the hub 730.

The routed traffic includes the message that was sent by 711. After being processed by the hub 730, the message is forwarded to domain gateway 723, then to UC system 722, and finally to user 721. As FIG. 7 illustrates, the FQDN field in the entry for domain “x.com” in allow list 750 also needs to include the address of the hub 730 (“hub_addr”). As such, traffic intended for the domain “x.com” (710) is also routed through the hub 730.

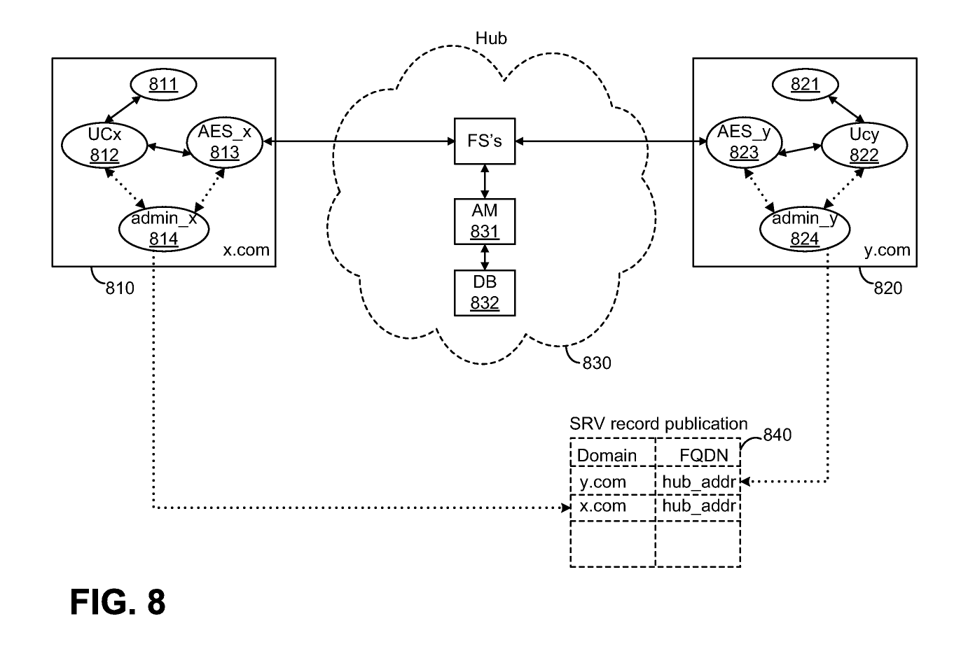

FIG. 8 illustrates a block diagram that traces an exemplary transmission of a message through a hub using SRV record publication, according to one embodiment. Assume user 811 wants to send a message to user 821. User 811 first sends the message to the local UC system 812. Next, the message is sent to domain gateway 813 and is intended to be transmitted to domain “y.com” (820). However, because the local administrators 814 and 824 have published the SRV records for domains “x.com” (810) and “y.com” (820), respectively, with the FQDN fields set as “hub_addr”, as shown in SRV record publication 840, all communications traffic that is intended for domains “x.com” and “y.com” 820 will be routed to the hub 830. In order for the hub 830 to handle the routed traffic, both domains (“x.com” and “y.com”) need to be added to the hub 830 through the AM 831. As FIG. 8 illustrates, the routed traffic includes the message that was sent by 811. After being processed by the hub 830, the message is forwarded to the domain gateway 823, then to the UC system 822, and finally to user 821.

SRV records enable a domain (e.g., foo.com) to become part of the hub without asking other domains to configure their gateways/allow lists to add the domain in order to direct traffic to the hub. Accordingly, using SRV records for multiple protocols along with the support for those multiple protocols in the hub enable a domain (e.g., foo.com) to appear as different UC systems. For instance, by publishing an SRV record for the respective protocol, foo.com may appear as an OCS system to other OCS partners, and at the same time, foo.com may appear as a XMPP system to XMPP partners.

The SRV record requirement varies among UC systems based on the UC protocol used by the UC system or even within that UC protocol a vendor may have a specialized SRV record requirement. A feature of the hub is that the administrator of a domain (e.g., “y.com”) can publish SRV records for all the UC system types that can federate (via the hub) with the domain (e.g., “y.com”). All these SRV records would point to the address for the hub (e.g., “hub.addr”). For instance, if “x.com” is an OCS UC system, then it would look up_sipfederationtls._tcp.y.com to federate with “y.com”. If “z.com” is a Jabber UC system, then it would look up_xmpp-server._tcp.y.com to federate with “y.com”. While “y.com” is a certain UC type (e.g., Sametime) but because of the SRV record publication and the hub, “y.com” appears as an OCS UC system to “x.com” and as a Jabber UC system to “z.com”.

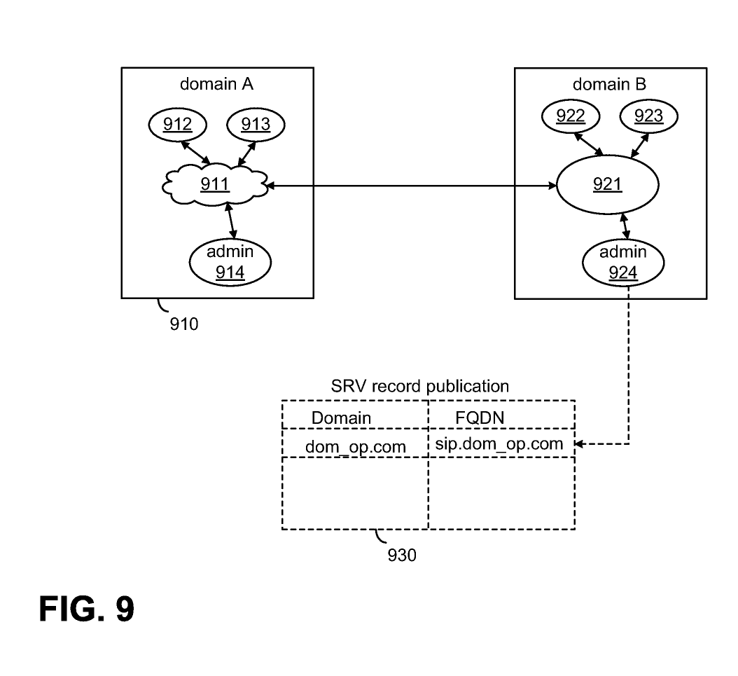

According to one embodiment, the present system allows a domain (herein also referred to as a “cloud domain”) of a cloud-based communications service to federate with a domain (herein also referred to as an “on-premise domain”) associated with a UC system such as an on-premise UC system. FIG. 9 illustrates a block diagram of an exemplary system for federating a cloud-based communications service with a unified communications system, according to one embodiment. A UC system 921 runs a UC application and is accessible (e.g., instant messaging, emailing, and video conferencing) by users 922 and 923 in domain B 920. As such, users 922 and 923 can communicate with one another through UC system 921.

A cloud-based communications service 911 runs a cloud-based subscription service and is accessible (e.g., instant messaging, emailing, and video conferencing) on the cloud by users 912 and 913 in domain A 910. Domain A 910 has a domain name “dom_365.com” and domain B 920 has a domain name “dom_op.com”. A local administrator 924 for domain B 920 publishes an SRV record for domain B 920, as shown in SRV record publication 930. In one embodiment, a local administrator 914 for domain A 910 also publishes an SRV record for domain A 910, which points to domain A 910.

For example, the local administrator 924 publishes an exemplary SRV record for domain B 920 as follows:

Type: SRV

Service: _sipfederationtls

Protocol: _tcp

Port: 5061

Weight: 1

Priority: 100

TTL: 1 Hour

Name: dom_op.com

Target: sip.dom_op.com

The SRV record publication 930 for domain B “dom_op.com” 920 points to UC system 921 with the FQDN field set as “sip.dom_op.com”.

In one embodiment, if domain B 920 wants to federate with domain A 910 using a federation system, the federation system requests a digital certificate on behalf of domain B 920 from a publicly trusted certification authority (e.g., ENTRUST®, DIGICERT® and VERISIGN®) configured with “sip.dom_op.com” as a subject name (SN) or a subject alternate name (SAN). Once the request is received by the certification authority, the certification authority sends an approval request to the administrator 924 of the domain A 920 to allow issue of the digital certificate for domain B 920 to the federation system. This request is send directly to the domain B 920 administrator 924, so that the administrator 924 can independently receive the approval request. Once the certification authority receives the approval from the administrator 924, the certification authority issues the digital certificate for domain B 920 to the federation system. The federation system then presents the digital certificate to domain A 910 and federates domain B 920 and domain A 910 based on the digital certificate.

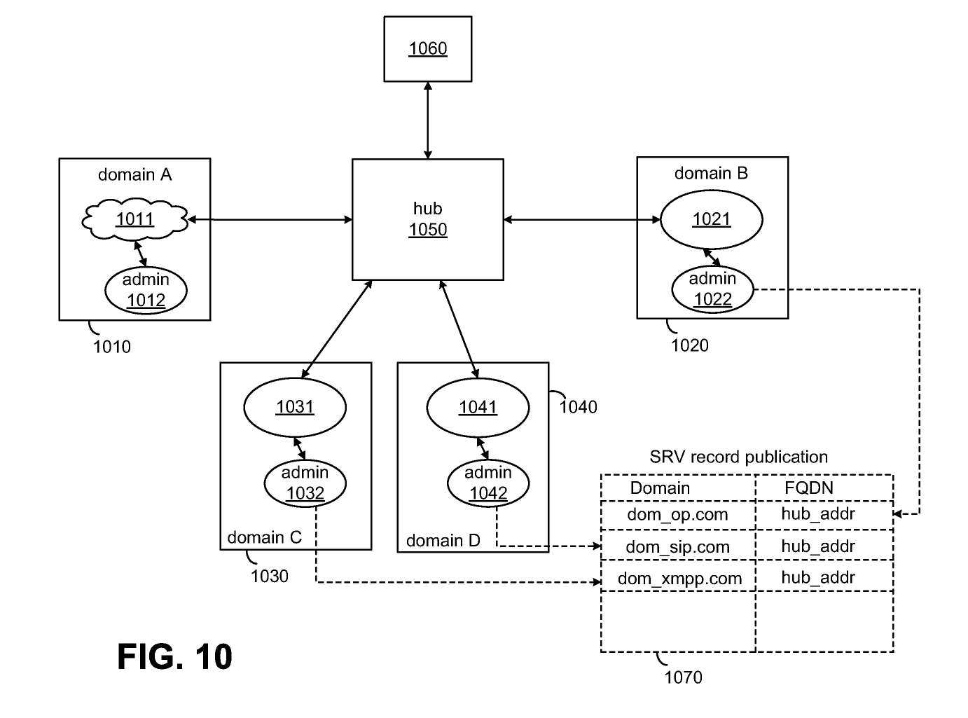

FIG. 10 illustrates a block diagram of an exemplary system for federating a cloud-based communications service with one or more unified communications systems, according to one embodiment. A hub 1050 is connected to and communicates with domain A 1010 using a cloud-based communications service 1011 and domain B 1020, domain C 1030, and domain D 1040 using respective UC systems 1021, 1031, and 1041. Domain A 1010 has a domain name “dom_365.com”. Domain B 1020 has a domain name “dom_op.com”. Domain C 1030 has a domain name “dom_xmpp.com”. Domain D 1040 has a domain name “dom_sip.com”.

The hub 1050 allows domain A 1010, domain B 1020, domain C 1030, and domain D 1040 to federate with one another. For domain A 1010 to federate with domain B 1020, a local administrator 1022 for domain B 1020 publishes an SRV record for domain B 1020, as shown in SRV record publication 1070.

For example, the local administrator 1022 publishes an exemplary SRV record for domain B 1020 as follows:

Type: SRV

Service: _sipfederationtls

Protocol: _tcp

Port: 5061

Weight: 1

Priority: 100

TTL: 1 Hour

Name: dom_op.com

Target: sip.dom_op.com

An additional canonical name (CNAME) record or an address (A) record is created to ensure that “sip.dom_op.com” of domain B 1020 points to the hub 1050. CNAME record has an entry for sip.dom_op.com of domain B 1020 pointing to the hub_addr. CNAME record is an additional record besides the SIP SRV record that maps the sip.dom_op.com of domain B 1020 in the SIP SRV to a hub_addr.

The hub 1050 sends a request to a certification authority 1060 to issue a digital certificate that contains the string “sip.dom_op.com” as an SN or an SAN. The hub 1050 presents the digital certificate to domain A 1010 to establish federation between domain A 1010 and domain B 1020.

If domain C 1030 needs to federate with domain A 1010, a local administrator 1032 for domain C 1030 publishes an SRV record for domain C 1030, as shown in SRV record publication 1070. For example, the local administrator 1032 publishes an exemplary SRV record for domain C 1030 as follows:

Type: SRV

Service: _sipfederationtls

Protocol: _tcp

Port: 5061

Weight: 1

Priority: 100

TTL: 1 Hour

Name: dom_xmpp.com

Target: sip.dom_xmpp.com

If domain D 1040 needs to federate with domain A 1010, a local administrator 1042 for domain D 1040 publishes an SRV record for domain D 1040, as shown in SRV record publication 1070. For example, the local administrator 1042 publishes an exemplary SRV record for domain D 1040 as follows:

Type: SRV

Service: _sipfederationtls

Protocol: _tcp

Port: 5061

Weight: 1

Priority: 100

TTL: 1 Hour

Name: dom_sip.com

Target: sip.dom_sip.com

Additional CNAME records are created to ensure that “sip.dom_xmpp.com” and “sip.dom_sip.com” of respective domain C 1030 and domain D 1040 point to the hub 1050. However, domain A 1010 publishes DNS SIP SRV record to itself and does not point to the hub 1050. Accordingly, when the cloud-based communications service 1011 for domain A 1010 attempts to communicate with domain B 1020, domain C 1030, and domain D 1040, domain A 1010 thinks that it is connecting to three different on-premise UC systems. The hub 1050 sends a request to a certification authority 1060 to issue a digital certificate that contains the strings “sip.dom_op.com”, “sip.dom_xmpp.com” for and “sip.dom_sip.com” respectively for domain B, domain C and domain D, as an SN or an SAN. The hub 1050 presents the digital certificate to domain A 1010 to establish federation between domain A 1010 and domain B 1020, domain C 1030 and domain D 1040.

Therefore, when domain A 1010 (e.g. a O365 domain) is federated with domain B 1020, domain C1030 and domain C 1040 (e.g. multiple other O365 domains) through a hub 1015 (e.g. NextPlane® federation system), presenting the correct digital certificate and the DNS SRV records as per the requirements for the Open Federation may be critical to establish the federation connection.

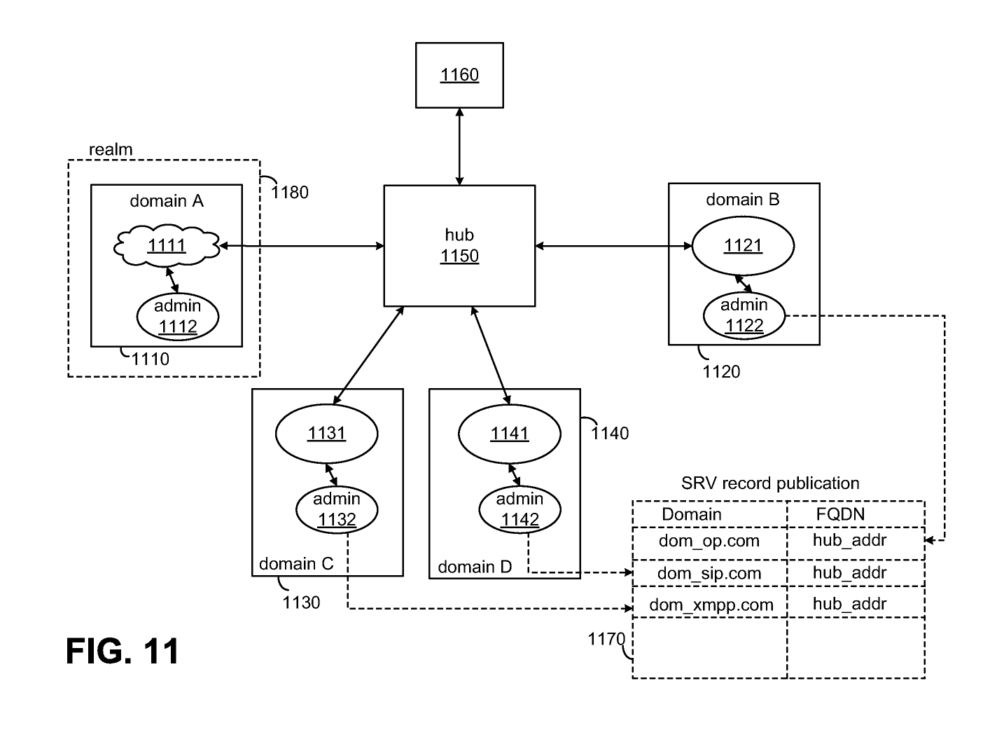

FIG. 11 illustrates a block diagram of an exemplary system for federating a cloud-based communications service with one or more unified communications systems, according to one embodiment. A hub 1150 is connected to and communicates with domain A 1110 using a cloud-based communications service 1111 and domain B 1120, domain C 1130, and domain D 1140 using respective UC systems 1121, 1131, and 1141. Domain A 1110 has a domain name “dom_365.com”. Domain B 1120 has a domain name “dom_op.com”. Domain C 1130 has a domain name “dom_xmpp.com”. Domain D 1140 has a domain name “dom_sip.com”.

The hub 1150 allows domain A 1110, domain B 1120, domain C 1130, and domain D 1140 to federate with one another. The hub 1150 assigns domain A 1110 to a realm 1180. The realm 1180 is a network region or network segment that is reachable through a particular network card. It is understood that the hub 1150 may assign any number of domains of a cloud-based communications service to the realm 1180 without deviating from the scope of the present disclosure. In one embodiment, the realm 1180 can be a part of the hub 1150 as well. The hub 1150 generates a certificate signing request (CSR) with a modified list attribute (e.g. Subject Alternative Name (SAN)) that includes domain B 1120, domain C 1130, and domain D 1140. The number of SANs that can be added to a CSR is limited. However, SAN can be spilt into multiple certificates on multiple realms to overcome such limitation.

The hub 1150 transmits the CSR to a certification authority 1160 (e.g., ENTRUST®, DIGICERT® and VERISIGN®) with SAN for domain B 1120, domain C 1130, and domain D 1140. Once the CSR is received by the certification authority 1160, the certification authority 1160 sends an approval request to the administrators 1122, 1132 and 1142 to allow issue of the digital certificates for domain B 1120, domain C 1130, and domain D 1140 to the hub 1150. This request is send directly to the administrators of domain B 1120, domain C 1130, and domain D 1140, so that the administrators 1122, 1132 and 1142 of the respective domain B 1120, domain C 1130, and domain D 1140, can independently receive the approval request. Once the certification authority 1160 receives the approval from the administrators 1122, 1132 and 1142 of the respective domain B 1120, domain C 1130, and domain D 1140, the certification authority issues the digital certificates for such domains to the hub 1150. The hub 1150 then presents the digital certificates of domain B 1120, domain C 1130, and domain D 1140 to domain A 1110 and federates domain B 1120, domain C 1130, and domain D 1140 and domain A 910 based on the digital certificates. In some cases, the digital certificates are stored in a database in the hub 1150.

The cloud-based communications service 1111 for domain A 1110 accepts the digital certificate for establishing federation with any of domain B 1120, domain C 1130, and domain D 1140. The local administrators 1122, 1132, and 1142 of respective domain B 1120, domain C 1130, and domain D 1140 publishes appropriate SRV records, as shown in SRV record publication 1170 to point to the realm 1180 so that communications traffic from domain A 1110 to any of domain B 1120, domain C 1130, and domain D 1140 passes through the realm 1180. In this exemplary case, the realm 1180 is a part of the hub 1150 to which the traffic is sent as per the SRV record.

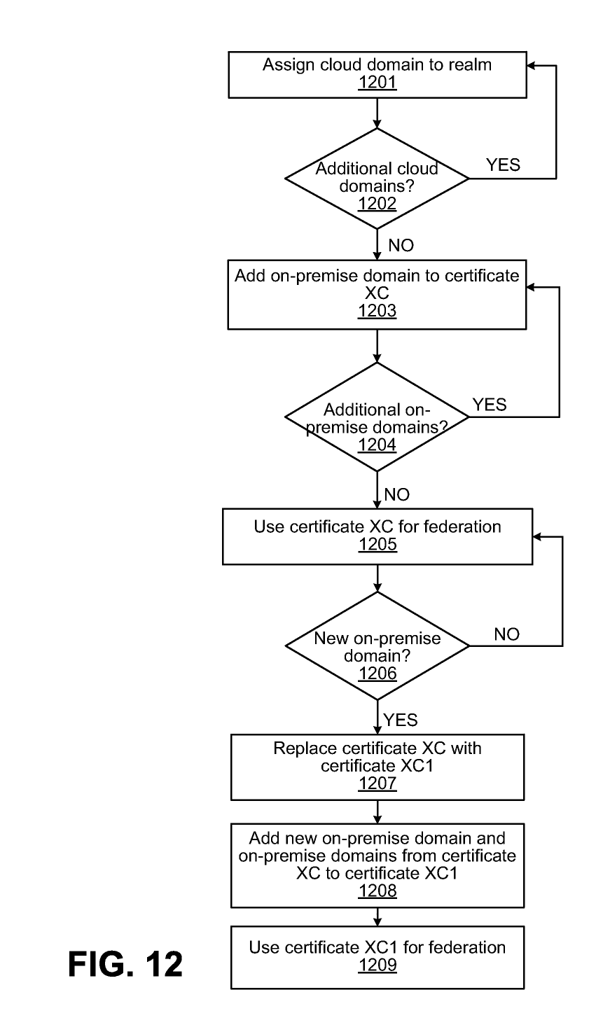

FIG. 12 illustrates a flow chart of an exemplary process for providing a digital certificate to establish a federation between two or more domains, to one embodiment. The present system assigns a cloud domain (e.g., a domain name “dom_365.com”) to a realm (e.g., realm X) (at 1201). The present system presents a digital certificate for the realm when negotiating with the cloud domain (e.g., using SIP TLS negotiation, for example, please see “Some Thoughts on System Design to Facilitate Resource Sharing”; R. Watson; November 1973; http://tools.ietf.org/html/rfc5922 and “SIP: Session Initiation Protocol”, J. Rosenberg, dynamicsoft; H. Schulzrinne, Columbia U.; G. Camarillo, Ericsson; A. Johnston, WorldCom; J. Peterson, Neustar; R. Sparks, dynamicsoft; M. Handley, ICIR; E. Schooler, AT&T; June 2002; http://tools.ietf.org/html/rfc3261#section-26.4.3; incorporated herein as references in their entirety). The present system determines whether there are additional cloud domains (at 1202). If there is an additional cloud domain, the present system assigns the additional cloud domain to the realm (at 1201). If there are no more cloud domains, the present system adds an on-premise domain that needs to federate with the cloud domain to a digital certificate XC (at 1203). According to one embodiment, the present system generates a CSR with a modified list attribute that includes the on-premise domain for the digital certificate XC. The present system further transmits the CSR to a certification authority and have the administrator of the UC system for the on-premise domain work with the certification authority to issue the digital certificate XC.

The present system determines whether there is an additional on-premise domain that need to federate with the cloud domain (at 1204). If there is an additional on-premise domain, the present system continues to add the on-premise domain to the digital certificate XC (at 1203). If there are no more on-premise domains, the present system uses the digital certificate XC to establish federated communication between the on-premise domain(s) and the cloud domain(s) in the realm (at 1205). The present system presents the digital certificate XC to the realm. The cloud domain(s) in the realm accept the digital certificate XC for establishing federation with any of the on-premise domain(s). According to one embodiment, the digital certificate presented by the present system is a subject alternative name (SAN) certificate that represents all the on-premise domains that need to federate with the cloud domain(s) in the realm.

For example, if there are five on-premise domains D1, D2, D3, D4, and D5 that collectively need to federate with the cloud domain(s) in the realm, the digital certificate contains the five on-premise domains D1, D2, D3, D4, and D5 in its SAN list. Alternatively, the digital certificate contains the equivalent target string names of the five domains D1, D2, D3, D4, and D5 in its SAN list.

The present system further determines if there is a new on-premise domain that needs to federate with any cloud domain(s) in the realm (at 1206). If there are no new on-premise domains, the present system continues to use the digital certificate XC to establish federation (at 1205). If there is a new on-premise domain, the certification authority (e.g., ENTRUST®, DIGICERT® and VERISIGN®) issues a new certificate XC1, since they cannot append anything to existing certificate XC. In this case, XC1 is a brand new certificate issued with an added SAN domain which contains a new validity period and serial number. Next, the present system replaces the digital certificate XC with a new digital certificate XC1 (at 1207). The present system adds the new on-premise domain and the on-premise domains previously listed in the digital certificate XC to the digital certificate XC1 (at 1208).

According to one embodiment, the present system generates a subsequent CSR with a modified list attribute that includes the new on-premise domain for the new digital certificate XC1. The present system further transmits the CSR to a certification authority and have the administrator of the UC system for the new on-premise domain work with the certification authority to issue the digital certificate XC1. The new digital certificate XC1 includes the new on-premise domain and the on-premise domains previously listed in the digital certificate XC. Referring to the above example, if a new on-premise domain D6 needs to federate with any cloud domain(s) in the realm, the present system replaces a digital certificate XC with a new digital certificate XC1 so that the SAN list of the digital certificate XC1 includes D6 in addition to D1, D2, D3, D4, and D5.

The present system uses the digital certificate XC1 to establish federation between the on-premise(s) domains and the cloud domain(s) in the realm (at 1209). The present system further creates an appropriate SRV record to point to the realm so that a message that originates from any of the cloud domain(s) in the realm to an on-premise domain listed in the digital certificate passes through the realm. For example, following is two SRV records that points to the realm:

1> _sipfederationtls._tcp.foobar.com SRV service location:

priority=20

weight=20

port=5061

svr hostname=sip.foobar.com

2> sip.foobar.com canonical name=sip.foobar.com.ucfederation.com

According to one embodiment, the digital certificate has a maximum number of domains that can be listed. For example, the SAN certificate has a maximum number of SANs in the SAN list. The maximum number may be based on a vendor that issues the digital certificate. For example, the maximum number is 100. This means that the maximum number of on-premise domains that can federate with a cloud domain in a realm (e.g., realm X) is 100 (e.g., domains D1 to D100). If a 101th on-premise domain D101 needs to federate with the cloud domain in the realm, the present system provides a realm routing logic to select a realm to send a message to the cloud domain.

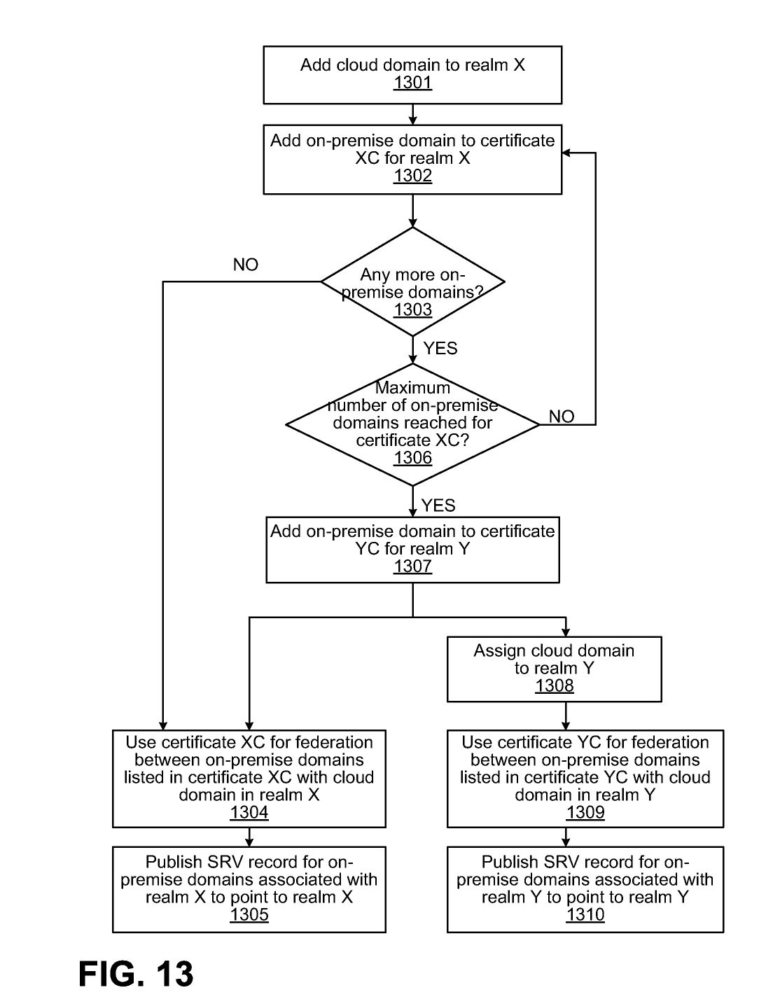

FIG. 13 illustrates a flow chart of an exemplary process for realm routing, according to one embodiment. The present system adds a cloud domain to realm X (at 1301). The present system adds an on-premise domain that needs to federate with a cloud domain in a realm X to a digital certificate XC (at 1302). According to one embodiment, the present system provides a user interface to allow a user (e.g., an administrator) to associate an on-premise domain with realm X. In this case, the administrator or user can be added in an administration module of the hub. The on-premise domain that is added to digital certificate XC is associated with realm X. The present system generates a CSR with a modified list attribute that includes the on-premise domain for the digital certificate XC. The present system further transmits the CSR to a certification authority and have the administrator of the UC system for the on-premise domain work with the certification authority to issue the digital certificate XC. The present system determines whether there is an additional on-premise domain (at 1303). If there are no more on-premise domains, the present system uses the digital certificate XC to establish federation between the on-premise domain(s) associated with realm X and the cloud domain in realm X (at 1304). The present system presents the digital certificate XC to the remote endpoint (i.e., a server) for the cloud domain, where the digital certificate XC represents the on-premise domain(s) associated with realm X. The present system publishes an SRV record for the on-premise domain(s) associated with realm X to point to realm X (at 1305). This ensures that a message from the cloud domain in realm X to one or more on-premise domains associated with realm X passes through realm X.

If there is an additional on-premise domain, the present system further determines whether the maximum number of on-premise domains in the digital certificate XC is reached (at 1306). If the maximum number of on-premise domains is not reached, the present system continues to add the additional on-premise domain to the digital certificate XC (at 1302). If the maximum number of on-premise domains is reached, the present system adds the additional on-premise domain to another digital certificate YC that corresponds to a realm Y (at 1307). According to one embodiment, the present system provides a user interface to allow a user (e.g., an administrator) to associate the additional on-premise domain with realm Y. The additional on-premise domain that is added to digital certificate YC is associated with realm Y. The present system generates a subsequent CSR with a modified list attribute that includes the additional on-premise domain for the digital certificate YC. The present system further transmits the CSR to a certification authority and have the administrator of the UC system for the additional on-premise domain work with the certification authority to issue the digital certificate YC.

For example, the maximum number of on-premise domains in digital certificate XC is 100. The present system associates domains D1 to D100 with realm X. If there is an additional on-premise domain D101, the present system associates D101 with realm Y.

The present system further assigns the cloud domain (that is also assigned to realm X) to realm Y (at 1308). The present system uses digital certificate YC to establish federation between the on-premise domain(s) associated with realm Y and the cloud domain in realm Y (at 1309). The present system further publishes an SRV record for the on-premise domain(s) associated with realm Y to point to realm Y (at 1310). This ensures that a message from the cloud domain in realm Y to one or more on-premise domains associated with realm Y comes via realm Y. According to one embodiment, if an on-premise domain is not associated with any realm, the present system specifies a default realm for the cloud domain.

It is noted that the on-premise domain to realm configuration setting is independent of the actual number of cloud domains that are present in a realm. For example, if there are two cloud domains (e.g., domain names “dom_365.com” and “dom1_365.com”) present in realm X, then the on-premise domains associated with realm X are independent of the cloud domains (e.g., domain names “dom_365.com” and “dom1_365.com”).

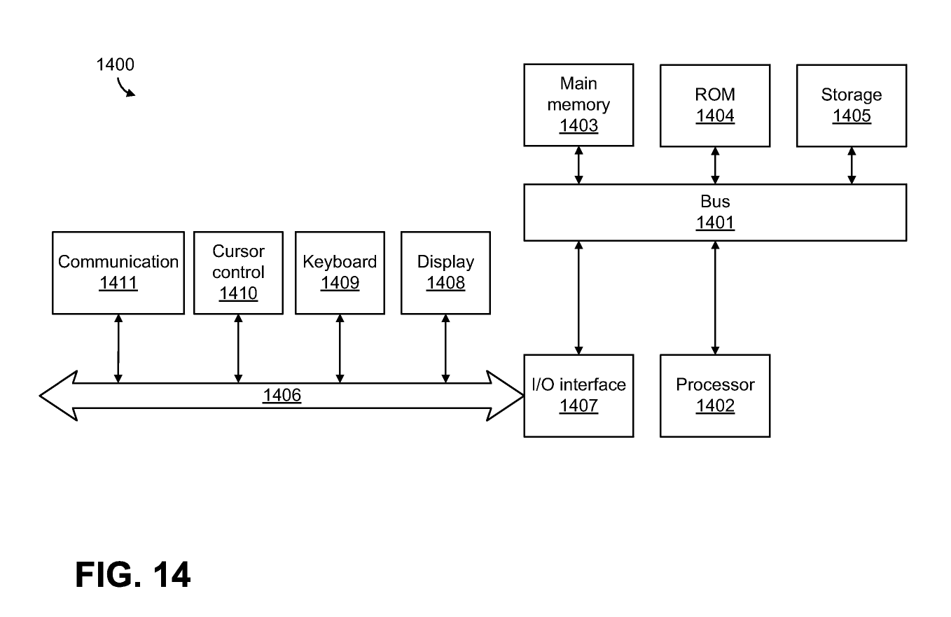

FIG. 14 illustrates an exemplary computer architecture that may be used for the present system, according to one embodiment. The exemplary computer architecture may be used for implementing one or more components described in the present disclosure including, but not limited to, the present system. One embodiment of architecture 1400 includes a system bus 1401 for communicating information, and a processor 1402 coupled to bus 1401 for processing information. Architecture 1400 further includes a random access memory (RAM) or other dynamic storage device 1403 (referred to herein as main memory), coupled to bus 1401 for storing information and instructions to be executed by processor 1402. Main memory 1403 also may be used for storing temporary variables or other intermediate information during execution of instructions by processor 1402. Architecture 1400 may also include a read only memory (ROM) and/or other static storage device 1404 coupled to bus 1401 for storing static information and instructions used by processor 1402.

A data storage device 1405 such as a magnetic disk or optical disc and its corresponding drive may also be coupled to architecture 1400 for storing information and instructions. Architecture 1400 can also be coupled to a second I/O bus 1406 via an I/O interface 1407. A plurality of I/O devices may be coupled to I/O bus 1406, including a display device 1408, an input device (e.g., an alphanumeric input device 1409 and/or a cursor control device 1410).

The communication device 1411 allows for access to other computers (e.g., servers or clients) via a network. The communication device 1411 may include one or more modems, network interface cards, wireless network interfaces or other interface devices, such as those used for coupling to Ethernet, token ring, or other types of networks.

The above example embodiments have been described hereinabove to illustrate various embodiments of implementing a system and method of federating a cloud-based communications service with a unified communications system. Various modifications and departures from the disclosed example embodiments will occur to those having ordinary skill in the art. The subject matter that is intended to be within the scope of the disclosure is set forth in the following claims.

We claim:

1. A system, comprising:
a federation system that is connected to a first domain of a unified communications system and a second domain of a cloud-based communications service,
wherein the federation server assigns the second domain to a first network region via a first network card,
wherein the federation system provides a first request to a certification authority to issue a first digital certificate, wherein the first request includes an attribute of the first domain,
wherein the federation system receives the first digital certificate from the certification authority,
wherein the federation system presents the first digital certificate to the first network region, and
wherein the federation system federates the first domain and the second domain based on the first digital certificate.

2. The system of claim 1, wherein the attribute includes a subject alternate name of the first domain.

3. The system of claim 1, wherein the federation system is connected to a third domain of the cloud-based communications service, and wherein the federation system assigns the third domain to the first network region.

4. The system of claim 1, wherein the federation system is connected to a first plurality of domains, wherein each of the first plurality of domains is supported by each of a corresponding plurality of unified communications systems, wherein the first plurality of domains corresponds to a maximum number listed in the first digital certificate,
wherein the federation system provides the first request to the certification authority to issue the first digital certificate, wherein the first request includes attributes of the first plurality of domains, and
wherein the federation system federates the first plurality of domains and the first domain based on the first digital certificate.

5. The system of claim 4, wherein the federation system assigns the second domain to a second network region via a second network card.

6. The system of claim 5, wherein the federation system is connected to a second plurality of domains, wherein the second plurality of domains is supported by one of a same type or a different type of unified communications systems,
wherein the federation system provides a second request to the certification authority to issue a second digital certificate, wherein the second request includes attributes of the second plurality of domains,
wherein the federation system receives the second digital certificate from the certification authority,
wherein the federation system presents the second digital certificate to the second network region, and
wherein the federation system federates the second plurality of domains and the second domain based on the second digital certificate.

7. A method, comprising:
connecting a first domain of a unified communications system and a second domain of a cloud-based communications service through a federation system;
assigning the second domain to a first network region via a first network card,
providing a first request to a certification authority to issue a first digital certificate, wherein the first request includes an attribute of the first domain,
receiving the first digital certificate from the certification authority,
presenting the first digital certificate to the first network region, and
federating the first domain and the second domain based on the first digital certificate.

8. The method of claim 7, wherein the attribute includes a subject alternate name of the first domain.

9. The method of claim 7, further comprising:
connecting a third domain of the cloud-based communications service through the federation system, and
assigning the third domain to the first network region.

10. The method of claim 7, further comprising:
connecting a first plurality of domains through the federation system, wherein the first plurality of domains is supported by one of a same type or a different type of unified communications systems, wherein the first plurality of domains corresponds to a maximum number listed in the first digital certificate;
providing the first request to the certification authority to issue the first digital certificate, wherein the first request includes attributes of the first plurality of domains; and
federating the first plurality of domains and the first domain based on the first digital certificate.

11. The method of claim 10, further comprising assigning the second domain to a second network region via a second network card.

12. The method of claim 11, further comprising:
connecting a second plurality of domains through the federation system, wherein the second plurality of domains is supported by one of the same type or the different type of unified communications systems;
providing a second request to the certification authority to issue the a second digital certificate, wherein the second request includes attributes of the second plurality of domains;
receiving the second digital certificate from the certification authority;
presenting the second digital certificate to the second network region; and
federating the second plurality of domains and the second domain based on the second digital certificate.

13. The method of claim 7, further comprising publishing a service record to direct a message from the second domain to the first domain via the first network region.

14. The method of claim 10, further comprising publishing a service record to direct a message from the second domain to one of the first plurality of domains via the first network region.

15. The method of claim 12, further comprising publishing a service record to direct a message from the second domain to one of the second plurality of domains via the second network region.
